(19) United States
(12) Patent Application Publication
(10) Pub. No.: US 2006/0266895 A1
(43) Pub. Date: Nov. 30, 2006

(54) Temperature controlled, universal mounting assembly

(75) Inventor: David Francis Arnone, Mountain View, CA (US)

Correspondence Address: THE LAW OFFICE OF STEVEN G ROEDER, 5560 CHELSEA AVE, LA JOLLA, CA, 92037, US

(73) Assignee: BOOKHAM Technology plc

(21) Appl. No.: 11/436,927

(22) Filed: May 15, 2006

Related U.S. Application Data
(60) Provisional application No. 60/681,303, filed on May 16, 2005.

(51) Int. Cl. F16M 11/32

(52) U.S. Cl. 248/163.1

(57) ABSTRACT

A mounting assembly (16) for securing a device (12) to a mounting base (14) includes a mounting platform (18) and a temperature adjuster assembly (20). The mounting platform (18) is coupled to the mounting base (14). The mounting platform (18) includes a mounting surface (28) and a plurality of spaced apart mounting components (30) that are used to secure the device (12) to the mounting platform (18). The mounting components (30) are arranged in a mounting array. The temperature adjuster (20) adjusts the temperature of the mounting platform (18). The temperature adjuster (20) is in intimate thermal communication with the mounting platform (18).

### RELATED APPLICATION

This Application claims the benefit of U.S. Provisional Application Ser. No. 60/681,303 filed on May 16, 2005. The contents of U.S. Provisional Application Ser. No. 60/681,303 are incorporated herein by reference.

### BACKGROUND

Universal mounting breadboards are used to mount and hold one or more devices for testing, manufacturing, technical, or scientific instruments. These universal mounting breadboards can include a plurality of internally threaded holes arranged in a uniform pattern that allow for the easy attachment and alignment of the devices to the breadboard. Unfortunately, temperature changes caused by heat in the devices and/or the surrounding environment can influence the mechanical alignment of the devices that are secured to the universal mounting breadboards. This can significantly influence the performance of the assembly.

### SUMMARY

The present invention is directed to a mounting assembly for securing a device to a mounting base. The mounting assembly includes a mounting platform and a temperature adjuster. The mounting platform is coupled to the mounting base. The mounting platform includes a mounting surface and a plurality of spaced apart mounting components that are used to secure the device to the mounting platform. The mounting components are arranged in a mounting array. The temperature adjuster controls and adjusts the temperature of the mounting platform. Further, the temperature adjuster is in intimate thermal communication with the mounting platform. With this design, in certain embodiments, the mounting assembly maintains the devices in precise mechanical alignment as the ambient temperature drifts or at a temperature other than ambient temperature.

The mounting components are equally spaced apart in the mounting array. In one embodiment, at least one of the mounting components includes an internally threaded surface. The mounting platform can be made of a material having a relatively high coefficient of thermal conductivity. Further, the mounting platform can be made of a material having a relatively low coefficient of thermal expansion.

The temperature adjuster can include a resistor and/or a thermoelectric cooler that can be used to control the temperature of the mounting platform.

Additionally, the mounting assembly can include a temperature sensor assembly that senses the temperature of the mounting platform. Moreover, the mounting assembly can include a controller that receives information from the temperature sensor and that controls the temperature adjuster to precisely control the temperature of the mounting platform.

Further, the mounting assembly can include a mounting pedestal that secures the mounting platform to the mounting base with the mounting platform spaced apart from the mounting base. In one embodiment, the mounting pedestal includes an isolator that electrically isolates the mounting platform from the mounting base. Additionally or alternatively, the mounting pedestal can include an isolator that thermally isolates the mounting platform from the mounting base.

Additionally, the present invention is directed to method for making a precision apparatus. In one embodiment, the method includes the steps of securing a device to a mounting platform that includes a plurality of spaced apart mounting components and controlling the temperature of the mounting platform with a temperature adjuster that is in intimate thermal communication with the mounting platform.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified perspective illustration of a precision apparatus having features of the present invention;

FIG. 2 is a top view of a mounting platform having features of the present invention;

FIG. 3 is a cut-away view taken on line 3-3 in FIG. 2;

FIG. 4 is a simplified schematic of a circuit having features of the present invention;

FIG. 5 is a simplified perspective illustration of another embodiment of a precision apparatus having features of the present invention; and

FIG. 6 illustrates a top view of another embodiment of the mounting platform.

### DESCRIPTION

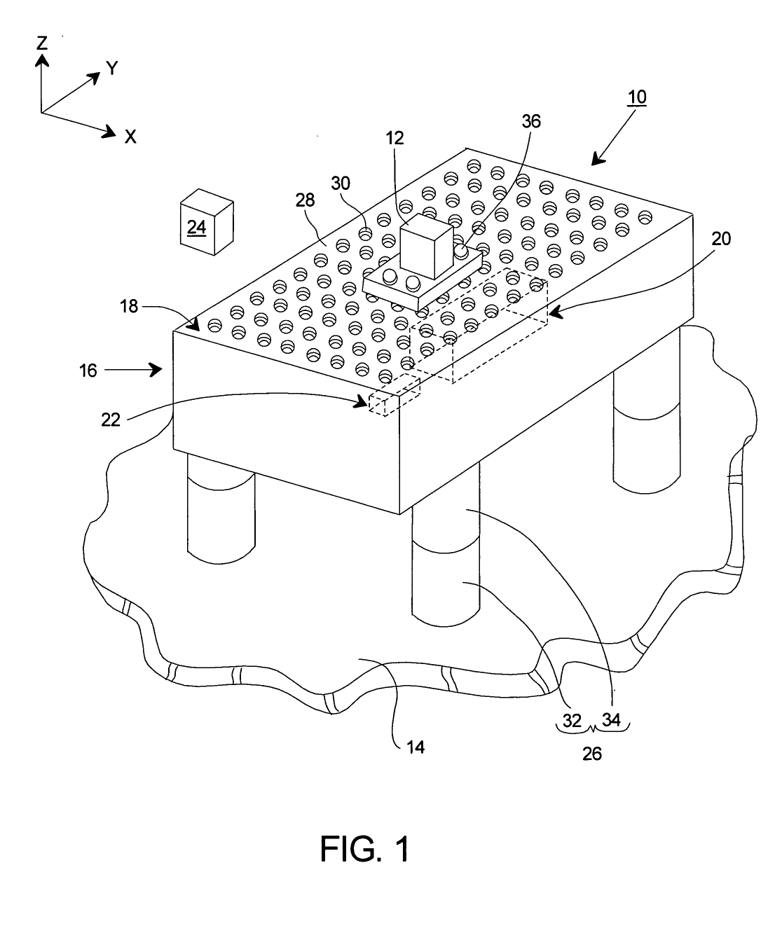

FIG. 1 illustrates one embodiment of a precision apparatus 10 having features of the present invention that, for example, can be used in manufacturing, testing, technical or scientific instruments. The design and orientation of the components of the precision apparatus 10 can be changed to suit the requirements of the precision apparatus 10. In FIG. 1, the precision apparatus 10 includes one or more devices 12 (only one is illustrated in FIG. 1), a mounting base 14 (only a portion is illustrated) and a mounting assembly 16 that retains the one or more devices 12 and that mechanically secures the one or more devices 12 to the mounting base 14. In certain embodiments, the mounting assembly 16 maintains the device(s) 12 in precise mechanical alignment as the ambient temperature drifts or at a temperature other than ambient temperature.

One or more of the Figures include an orientation system that illustrates an X axis, a Y axis that is orthogonal to the X axis and a Z axis that is orthogonal to the X and Y axes. It should be noted that these axes can also be referred to as the first, second and third axes.

The type and number of devices 12 retained by the mounting assembly 16 can vary according to the type of precision apparatus 10. For example, one or more of the devices 12 can be an optical lens, a filter, a mirror, a laser diode, an optical filter, a polarizer, a prism, an iris diaphragm, a filter wheel, a laser mount, a beam steerer, another type of optical component, or another type of element.

The mounting base 14 retains and/or supports at least some of the other components of the precision apparatus 10. In one embodiment, the mounting base 14 provides a rigid surface for retaining the mounting assembly 16. For example, the mounting base 14 can be large mechanical frame, such as a test stand.

The mounting assembly 16 secures the device(s) 12 to the mounting base 14. In the embodiment illustrated in FIG. 1, the mounting assembly 16 includes a mounting platform 18, a temperature adjuster assembly 20 (in phantom), a temperature sensor assembly 22 (in phantom), a controller 24, and one or more mounting pedestals 26. The design of these components can be varied to achieve the design requirements of the mounting assembly 16. Further, the mounting assembly 16 could be designed without some of these components. For example, in certain embodiments, the mounting platform 18 could be mounted directly to the mounting base 14 without the mounting pedestals 26. Further, the mounting assembly 16 could be designed without the temperature sensor assembly 22.

In certain embodiments, the mounting assembly 16 maintains the one or more device 12 in mechanical alignment as the ambient temperature drifts or at a temperature other than ambient.

The mounting platform 18 is coupled to the mounting base 14. The mounting platform 18 includes a mounting surface 28 and a plurality of spaced apart mounting components 30 that are used to secure the device(s) 12 to the mounting platform 18. The size and shape of the mounting platform 18 can be varied to achieve the desired use of the mounting platform 18. In FIG. 1, the mounting platform 18 is generally rectangular plate shaped and the mounting surface 28 is a generally flat surface. Alternatively, for example, the mounting platform 18 can have another shape. The mounting platform 18 can also be referred to as a breadboard.

In one embodiment, the mounting platform 18 is made of a material having a relatively high coefficient of thermal conductivity. In alternative, non-exclusive embodiments, the mounting platform is made of a material with a coefficient of thermal conductivity that is greater than approximately 90, 100, 150, 200, 250, 300, or 350 W/mK. With this design, the mounting platform 18 can be used to stabilize the temperature of the one or more device(s) 12 that are secured to the mounting platform 18. Suitable materials include aluminum or copper.

In another embodiment, the mounting platform 18 is made of a material having a relatively low coefficient of thermal expansion. In alternative, non-exclusive embodiments, the mounting platform 18 is made of a material with a coefficient of thermal expansion that is less than approximately 1.5, 2, or 2.5 ppm/K. With this design, the mounting platform 18 can be used to stabilize the mechanical position of the one or more device(s) 12 that are secured to the mounting platform 18. Suitable materials include steels with high nickel content such as Invar 36. Invar is a trademark of Carpenter Technology.

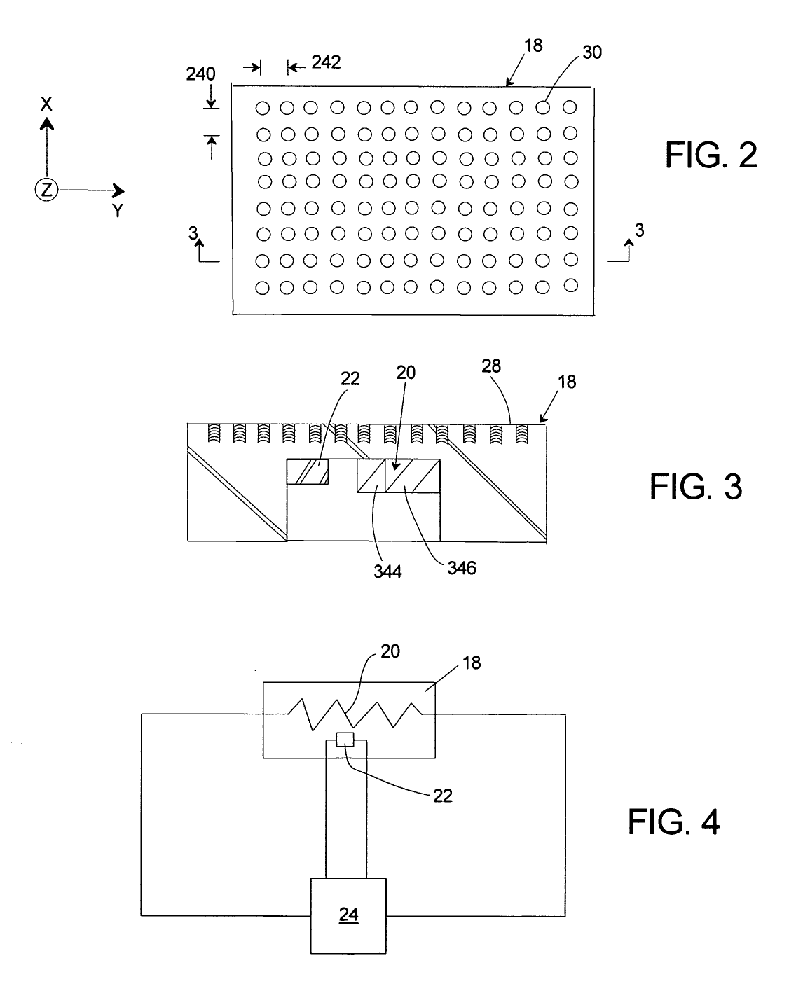

FIG. 2 illustrates a top view of the mounting platform 18. In this embodiment, the mounting components 30 are arranged in a mounting array with the mounting components 30 aligned along the X axis and along the Y axis. Further, the mounting components 30 are evenly spaced apart along the X axis and the mounting components 30 are evenly spaced apart along the Y axis. In alternative, non-exclusive embodiments, an X spacing 240 of adjacent mounting components 30 along the X axis is approximately equal to 0.5, 1, 1.5, 2, 2.5, or 3 inches and a Y spacing 242 of adjacent mounting components 30 along the Y axis is approximately equal to 0.5, 1, 1.5, 2, 2.5, or 3 inches. However, other distances can be utilized. In one embodiment, the X spacing 240 is equal to the Y spacing 242.

Alternatively, the mounting array can have another pattern. For example, the mounting array can include mounting components 30 arranged in a concentric circle pattern.

The number of mounting components 30 can vary. In alternative non-exclusive embodiments, the number of mounting components 30 can be equal to approximately 10, 20, 30, 40, 50, 60 or 100. However, a greater number or fewer mounting components 30 can be utilized.

With this design, the mounting platform 18 provides a general purpose, universal attachment arrangement that can be utilized to mounting many different types of devices 12.

The design of each mounting component 30 can be varied. In one embodiment, each of the mounting components 30 is an internally threaded mounting hole. With this design, one or more externally threaded fasteners 36 (illustrated in FIG. 1) can be threaded into one or more corresponding mounting components 30 to secure the device 12 to the mounting platform 18.

FIG. 3 is a cut-away view of the mounting platform 18, the temperature adjuster assembly 20, and the temperature sensor assembly 22. In this embodiment, the temperature adjuster assembly 20 is used to control and adjust the temperature of the mounting platform 18 and the temperature sensor assembly 22 senses the temperature of the mounting platform 18. With this design, the mounting assembly 16 is a temperature stabilized breadboard that is controlled by the controller 24.

The temperature adjuster assembly 20 is coupled to and in direct, intimate thermal contact with the mounting platform 18. Further, in this embodiment, the temperature adjuster assembly 20 is positioned below the mounting surface 28 of the mounting platform 18. Additionally, the temperature adjuster assembly 20 can heat and/or cool the mounting platform 18. In one embodiment, the temperature adjuster assembly 20 includes one or more heaters 344 and one or more coolers 346. For example, the temperature adjuster assembly 20 can include one or more resistive elements. Alternatively, or additionally, the temperature adjuster assembly 20 can include one or more thermoelectric coolers and/or one or more heat exchangers that utilize a cooling or heating fluid.

The temperature sensor assembly 22 senses the temperature of at least a portion of the mounting platform 18. Further, the temperature sensor assembly 22 is coupled to and in direct, intimate thermal contact with the mounting platform 18. Moreover, in this embodiment, the temperature sensor assembly 22 is positioned below the mounting surface 28 of the mounting platform 18. In one embodiment, the temperature sensor assembly 22 senses the temperature of the mounting platform 18 near the mounting surface 28. The temperature sensor assembly 22 can include one or more sensors the measure temperature. Suitable sensors include thermocouples, thermistors, integrated circuit temperature transducers, and thermopiles.

FIG. 4 is a simplified schematic of a circuit that illustrates the mounting platform 18, the temperature adjuster assembly 20, the temperature sensor assembly 22, and the controller 24. In this embodiment, the controller 24 is electrically connected to and directs power to the temperature adjuster assembly 20 to precisely control the operation of the temperature adjuster assembly 20 and control the temperature of the mounting platform 18. Further, the controller 24 is electrically connected to and receives temperature information from the temperature sensor assembly 22. With this design, the temperature adjuster assembly 20 can be controlled in a closed loop fashion. Alternatively, the temperature adjuster assembly 20 could be controlled in an open loop fashion.

Referring back to FIG. 1, the one or more mounting pedestals 26 secure the mounting platform 18 to the mounting base 14 with the mounting platform 18 spaced apart from the mounting base 14. In FIG. 1, four mounting pedestals 26 (only three are visible) are utilized. Alternatively, the mounting assembly 16 can include more than four or less than four mounting pedestals 26.

In FIG. 1, each mounting pedestal 26 includes a lower spacer 32 that is secured to the mounting base 14, and an isolator assembly 34 that is secured to the mounting platform 18. Alternately, the spacer 32 and isolator assembly 34 can be switched or each mounting pedestal 26 can be designed without the spacer 32 or the isolator assembly 34.

Further, in FIG. 1, the spacer 32 and the isolator assembly 34 are each generally right cylindrical shaped. Alternatively, the spacer 32 and/or the isolator assembly 34 can have another shape or configuration.

In one embodiment, the spacer 32 is made of a rigid material, e.g. metal, and the isolator assembly 34 is made of a material that isolates the mounting pedestal 26 from the mounting base 14. For example, the isolator assembly 34 can be made of a material with a relatively low coefficient of thermal conductivity. In alternative, non-exclusive embodiments, the isolator assembly 34 is made of a material with a coefficient of thermal conductivity that is less than approximately 4, 5, or 6 W/mK. With this design, the mounting pedestal 26 is thermally isolated from the mounting base 14. As a result thereof, the temperature of the mounting base 14 does not significantly influence the temperature of the mounting pedestal 26. Suitable materials for the isolator assembly 34 include ceramic materials such as Macor. Macor is a trademark of Corning Incorporated.

Alternatively or additionally, the isolator assembly 34 can be made of a material with a relatively low electrical conductivity. In a non-exclusive embodiment, the isolator assembly 34 is made of a material with an electrical resistance of greater than approximately 10¹⁶ ohm-cm. With this design, the mounting pedestal 26 is electrically isolated from the mounting base 14.

In another embodiment, the isolator 34 is made of a material with a relatively low electrical conductivity and with a relatively low coefficient of thermal conductivity.

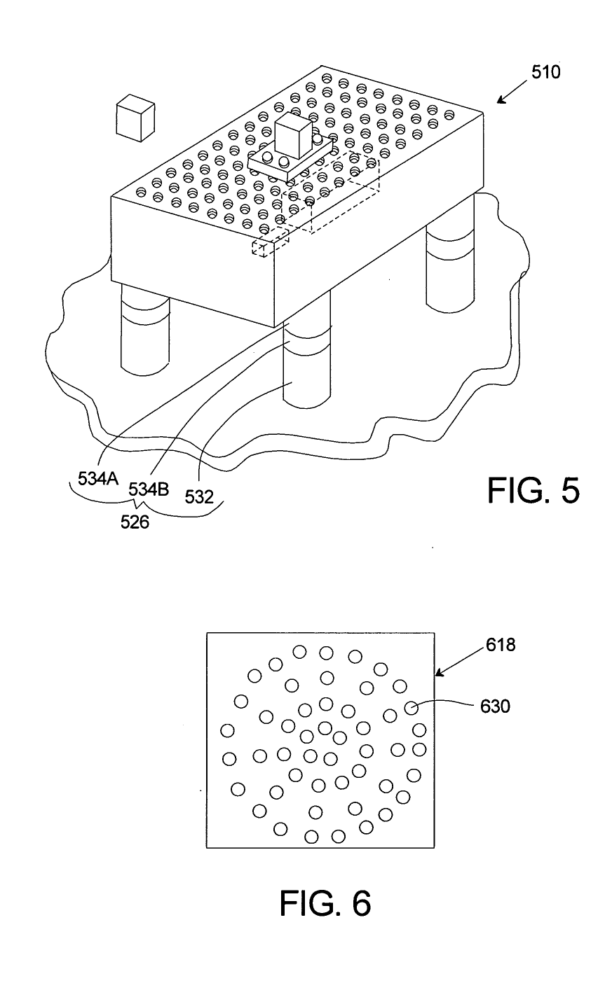

FIG. 5 is a simplified perspective illustration of another embodiment of a precision apparatus 510 that is somewhat similar to the precision apparatus 10 illustrated in FIG. 1 and described above. However, in this embodiment, each mounting pedestal 526 includes a spacer 532, a first isolator 534A that is made of a material with a relatively low electrical conductivity and a second isolator 534B that is made of a material with a relatively low coefficient of thermal conductivity.

FIG. 6 illustrates a top view of another embodiment of the mounting platform 618. In this embodiment, the mounting components 630 are arranged in a mounting array with the mounting components 630 arrange in a concentric circle pattern. It should be noted that other arrangements for the mounting components 630 can be utilized.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mounting assembly for securing a device to a mounting base, the mounting assembly comprising:
a mounting platform that is coupled to the mounting base, the mounting platform including a mounting surface and a plurality of spaced apart mounting components that are used to secure the device to the mounting platform, the mounting components being arranged in a mounting array; and
a temperature adjuster that adjusts the temperature of the mounting platform, the temperature adjuster being in intimate thermal communication with the mounting platform.

2. The mounting assembly of claim 1 wherein the mounting components are equally spaced apart in the mounting array.

3. The mounting assembly of claim 1 further comprising a temperature sensor assembly that senses the temperature of the mounting platform.

4. The mounting assembly of claim 3 further comprising a controller that receives information from the temperature sensor and that controls the temperature adjuster to precisely control the temperature of the mounting platform.

5. The mounting assembly of claim 1 wherein at least one of the mounting components includes an internally threaded surface.

6. The mounting assembly of claim 1 wherein temperature adjuster is positioned below the mounting surface.

7. The mounting assembly of claim 1 wherein temperature adjuster includes at least one of a resistor and a thermoelectric cooler.

8. The mounting assembly of claim 1 wherein the mounting platform is made of a material having a relatively high coefficient of thermal conductivity.

9. The mounting assembly of claim 1 wherein the mounting platform is made of a material having a relatively low coefficient of thermal expansion.

10. The mounting assembly of claim 1 further comprising a mounting pedestal that secures the mounting platform to the mounting base with the mounting platform spaced apart from the mounting base.

11. The mounting assembly of claim 10 wherein the mounting pedestal includes an isolator that electrically isolates the mounting platform from the mounting base.

12. The mounting assembly of claim 10 wherein the mounting pedestal includes an isolator that thermally isolates the mounting platform from the mounting base.

13. A precision apparatus comprising a device, a mounting base, and the mounting assembly of claim 1 that secures the device to the mounting base.

14. A mounting assembly for securing a device to a mounting base, the mounting assembly comprising:
a mounting platform that is coupled to the mounting base, the mounting platform including a mounting surface and a plurality of spaced apart mounting components that are used to secure the device to the mounting platform, the mounting components being arranged in a mounting array; and
an isolator assembly that electrically and thermally isolates the mounting platform from the mounting base.

15. The mounting assembly of claim 14 further comprising a temperature adjuster that adjusts the temperature of the mounting platform, the temperature adjuster being in intimate thermal communication with the mounting platform, the temperature adjuster being positioned below the mounting surface of the mounting platform.

16. The mounting assembly of claim 15 further comprising a temperature sensor assembly that senses the temperature of the mounting platform.

17. The mounting assembly of claim 16 further comprising a controller that receives information from the temperature sensor and that controls the temperature adjuster to precisely control the temperature of the mounting platform.

18. The mounting assembly of claim 14 wherein the mounting platform is made of a material having a relatively high coefficient of thermal conductivity.

19. The mounting assembly of claim 14 wherein the mounting platform is made of a material having a relatively low coefficient of thermal expansion.

20. A precision apparatus comprising a device, a mounting base, and the mounting assembly of claim 14 that secures the device to the mounting base.

21. A method of making a precision apparatus comprising the steps of:
securing a device to a mounting platform that includes a mounting surface and a plurality of spaced apart mounting components that are used to secure the device to the mounting platform, the mounting components being arranged in a mounting array; and
adjusting the temperature of the mounting platform with a temperature adjuster that is in intimate thermal communication with the mounting platform.

22. The method of claim 21 further comprising the step of sensing the temperature of the mounting platform with a temperature sensor assembly.

23. The method of claim 22 further comprising the step of controlling the temperature adjuster with a controller that receives information from the temperature sensor and that controls the temperature adjuster to precisely control the temperature of the mounting platform.
